(19) United States
(12) Patent Application Publication
(10) Pub. No.: US 2014/0205491 A1
(43) Pub. Date: Jul. 24, 2014

(54) COPPER ALLOY MATERIAL

(71) Applicant: HITACHI METALS, LTD., TOKYO (JP)

(72) Inventors: Keisuke FUJITO, Mito (JP); Seigi AOYAMA, Kitaibaraki (JP); Toru SUMI, Hitachi (JP); Hideyuki SAGAWA, Tokai-mura (JP); Yuju ENDO, Hitachi (JP)

(73) Assignee: HITACHI METALS, LTD., TOKYO (JP)

(21) Appl. No.: 14/140,615

(22) Filed: Dec. 26, 2013

(30) Foreign Application Priority Data
Jan. 18, 2013 (JP) 2013-007180

(51) Int. Cl. H01B 1/02; C22C 9/00

(52) U.S. Cl. CPC H01B 1/026; C22C 9/00
USPC 420/492

(57) ABSTRACT

A copper alloy material includes an additional element M including Ti, and a balance having copper and an inevitable impurity. An atomic ratio of the additional element M to oxygen is in a range of 0.33≦M/O≦1.5.

The present application is based on Japanese patent application No. 2013-007180 filed on Jan. 18, 2013, the entire contents of which are incorporated herein by reference.

### BACKGROUND OF THE INVENTION

1. Field of the Invention

The invention relates to a copper alloy material.

2. Description of the Related Art

According to the recent development of science and technology, devices using electricity as an energy source or a signal source have been increasingly produced. In such devices, conductive wires are used. Materials used for conductive wires are highly conductive metals such as copper and silver, and copper alloy materials using copper, etc., are often used in consideration of cost, etc.

In addition, due to demands of multi-functional, higher speed and smaller devices, conductive wires, etc., inside such devices are also required to have reduced size and diameter. However, since resistance of conductive wire is increased by reducing a diameter, it is necessary to use materials having higher conductivity for conductive wires. Thus, copper alloy materials, etc., with reduced impurities have been developed to increase conductivity of the conductive wires.

Meanwhile, heat treatment of copper alloy materials is commonly performed to change properties of the copper alloy materials used for conductive wires, etc., and copper alloy materials of which properties are changed by heat treatment at lower temperature are demanded from the viewpoint of reduction in manufacturing energy cost in recent years.

For example, Non-patent literature Hisashi Suzuki and Mikihiro Sugano, “Tetsu-To-Hagane (Iron and Steel)” (1984) No. 15, pp. 1977-1983 reports that a copper alloy material in which 4 to 28 mass ppm of Ti is added to electrolyte copper (Cu: 99.996 mass %) is softened by heat treatment at a lower temperature than without addition of Ti. The non-patent literature states that the reason why the copper alloy material is softened by heat treatment at low temperature is that combination of Ti with sulfur as an inevitable impurity forms a sulfide and a solid solution of sulfur in the copper alloy material is thereby reduced.

Japanese patent No. 4809934 discloses a dilute-copper alloy wire that contains 2 to 12 mass ppm of sulfur, 2 to 30 mass ppm of oxygen, 4 to 55 mass ppm of Ti and copper as the balance and has a conductivity of not less than 98% IACS and of which softening temperature is reduced to 130 to 148° C. by addition of Ti and resulting precipitation of sulfur as an inevitable impurity in copper.

### SUMMARY OF THE INVENTION

According to Japanese patent No. 4809934, Ti in an amount more than the theoretical amount is added to copper in order to ensure reaction between Ti and sulfur and this raises a concern that excessive Ti is solid-dissolved in copper. In addition, Ti is an active element and it is thus predicted that Ti reacts with oxygen in copper and forms TiO₂ which does not contribute to reaction with sulfur. It may be assumed that this results in formation of solid solution of sulfur in copper so as not to facilitate further reduction of softening temperature.

It is an object of the invention to provide a copper alloy material that has a low softening temperature and is excellent in conductivity and surface quality.

(1) According to one embodiment of the invention, a copper alloy material comprises:

an additional element M comprising Ti; and

a balance consisting copper and an inevitable impurity,

wherein an atomic ratio of the additional element M to oxygen is in a range of 0.33≦M/O≦1.5.

In the above embodiment (1) of the invention, the following modifications and changes can be made.

(i) The copper alloy material further comprises a half-softening temperature of less than 140° C.

(ii) The atomic ratio of the additional element M to oxygen is in a range of 0.5≦M/O≦1.

(iii) The copper alloy material further comprises a half-softening temperature of less than 130° C.

(iv) The copper alloy material further comprises an electrical conductivity of not less than 98% IACS.

(v) A molten copper before introducing the additional element M has an oxygen concentration of 2 to not more than 50 mass ppm.

(vi) The copper alloy material is formed by hot-rolling a cast product obtained by continuously casting.

### Effects of the Invention

According to one embodiment of the invention, a copper alloy material can be provided that has a low softening temperature and is excellent in conductivity and surface quality.

### BRIEF DESCRIPTION OF THE DRAWINGS

Next, the present invention will be explained in more detail in conjunction with appended drawings, wherein:

FIG. 1 is a characteristic diagram illustrating a relation between Ti/O atomic ratio and half-softening temperature.

### DETAILED DESCRIPTION OF THE PREFERRED EMBODIMENT

### Summary of the Embodiment

A copper alloy material in the present embodiment comprises an additional element and the balance which is copper with inevitable impurities. An additional element M to be added is Ti and an atomic ratio of the additional element M to oxygen is in a range of 0.33≦M/O≦1.5.

### First Embodiment

The copper alloy material in the present embodiment contains an additional element M which is one or more selected from Ti, Zr, Ca, Mg, B, Cr, Nb and V and the balance which is copper with inevitable impurities. Note that, the inevitable impurity means a substance inevitably mixed during the production process.

As a result of intense study, the inventors found that, in order to reduce softening temperature of copper alloy material, it is necessary to define not only the concentration ranges of the additional element M, oxygen and inevitable impurities but also a range of an atomic ratio of the additional element M to oxygen.

That is, with the addition of Ti as the additional element M, a half-softening temperature of copper alloy material is less than 140° C. when the atomic ratio of the additional element M to oxygen present in the copper alloy material is in a range of 0.33≦Ti/O≦1.5.

Furthermore, a half-softening temperature of the copper alloy material is less than 130° C. when the atomic ratio of the additional element M to oxygen is in a range of 0.5≦M/O≦1. As an oxide of oxygen and the additional element M, MO₂ is formed when the additional element M is Ti and Zn, MO is formed when the additional element M is Ca and Mg, M₂O₃ is formed when the additional element M is B and Cr, and M₂O₅ is formed when the additional element M is Nb and V. In addition, taking into consideration the case where the additional element M is other than Ti, an atomic ratio of the oxide MₓO_{y} is preferably in a range of 0.17≦[Mₓ/O_{y}]≦0.75.

The copper alloy material has a conductivity of not less than 98% IACS (IACS: International Annealed Copper Standard, conductivity of standard annealed copper having 1.7241×10⁻⁸ Ωm is defined as 100%).

Additional Element M

The additional element M, which is one or more selected from Ti, Zr, Ca, Mg, B, Cr, Nb and V to be added to the copper alloy material, is combined with sulfur as an inevitable impurity and forms a sulfide, resulting in precipitation of sulfur from the copper alloy material. Note that, the reason of using Ti, Zr, Ca, Mg, B, Cr, Nb and V as the additional element M is that such elements are active elements and are combined with elements such as sulfur.

Precipitation of sulfur caused by the additional element M reduces sulfur in the copper alloy material and thus increases purity of copper in the copper alloy material, resulting in reduction in a softening temperature of the copper alloy material. Note that, other elements and inevitable impurities which do not adversely affect the properties of the copper alloy material may be contained in the copper alloy material.

Oxygen Concentration in Molten Copper

If a large amount of oxygen is contained in molten copper which is a raw material of the copper alloy material, steam is generated by reaction of oxygen in molten copper with hydrogen contained in a molten copper-heating gas and causes a steam explosion on the surface of the molten copper or in the molten copper when the molten copper is solidified. The steam explosion forms blowholes, etc., in the copper alloy material and causes deterioration in the surface quality of the copper alloy material.

By setting the oxygen concentration in molten copper before addition of the additional element M to not more than 50 mass ppm as the upper limit, it is possible to suppress reaction of oxygen in the molten copper with hydrogen contained in the molten copper-heating gas. This suppresses generation of vapor and thus improves the surface quality of the copper alloy material. Furthermore, by adjusting the oxygen concentration in the molten copper before addition of the additional element M to not more than 20 mass ppm, it is possible to stably manufacture the copper alloy material with improved surface quality.

Meanwhile, it is difficult to adjust the oxygen concentration in the molten copper before addition of the additional element M to less than 2 mass ppm since it requires a substantial modification of continuous casting machine.

Sulfur Concentration in Molten Copper

The sulfur concentration in the molten copper before addition of the additional element M is desirably lower. Since general electrolytic copper to be a raw material of the copper alloy material is manufactured by electric purification in a cupric sulfate solution, incorporation of sulfur into the copper alloy material is unavoidable.

However, the sulfur concentration in general electrolytic copper does not exceed 12 mass ppm and such sulfur can be precipitated from the copper alloy material by adding the additional element M.

Method of Manufacturing Copper Alloy Material

Next, an example method of manufacturing a copper wire, which is an example of the copper alloy material, will be described.

Firstly, molten copper before addition of the additional element M and having an oxygen concentration of 2 to 50 mass ppm, preferably 5 to 20 mass ppm, is prepared. Next, the additional element M, which is Ti, is added to the prepared molten copper.

Next, the molten copper having the additional element M added thereto is continuously casted using a SCR (South Continuous Rod System) continuous casting and rolling method and a resulting cast product is hot-rolled, thereby manufacturing a copper wire at a compression ratio of 90% (diameter of 30 mm) to 99.8% (diameter of 5 mm). Note that, rolling the cast product at high temperature prevents hardening from occurring in the hot-rolled copper wire even at a high compression ratio.

Manufacturing Conditions of Copper Alloy Material

Next, the conditions to manufacture a copper wire having a conductivity of not less than 98% IACS at a compression ratio of 99.3% (diameter of 8 mm) will be described as an example of the manufacturing conditions of the copper alloy material.

The temperature of molten copper melted in a smelting furnace is preferably in a range of 1100 to 1320° C. When the temperature of the molten copper is high, more blowholes are formed in the molten copper and this causes deterioration in the surface quality of the copper alloy material, and also the grain size of the copper alloy material tends to be large. Therefore, the temperature of the molten copper is not more than 1320° C. Meanwhile, in case that the temperature of the molten copper is low, the molten copper is likely to be solidified and the copper alloy material is not stably manufactured but, on the other hand, the temperature of the molten copper is preferably as low as possible from the viewpoint of energy cost. Therefore, the temperature of the molten copper is not less than 1100° C.

In addition, the hot-rolling temperature of the cast product which has been continuously casted is preferably in a range of 750 to 880° C. at the initial roll and in a range of 550 to 750° C. at the final roll.

Hot-rolling the cast product at the molten copper temperature in the range of 1100 to 1320° C. and at the above-mentioned rolling temperatures allows a solid solubility limit of sulfur in the copper alloy material to be reduced.

Meanwhile, melting the molten copper in the smelting furnace causes incorporation of copper oxide and an enlarged particle size, which deteriorates the quality of the copper alloy material. Therefore, it is preferable to cast the molten copper under reductive gas (e.g., carbon monoxide) atmosphere while controlling the concentrations of sulfur, Ti and oxygen in the molten copper.

### Effects of the Embodiment

The present embodiment achieves the following effects.

(1) The atomic ratio of the additional element M to oxygen in the range of 0.33≦M/O≦1.5 allows the copper alloy material to have a softening temperature of less than 140° C. and a conductivity of not less than 98% IACS.

(2) The atomic ratio of the additional element M to oxygen in the range of 0.5≦M/O≦1 allows the copper alloy material to have a softening temperature of less than 130° C.

(3) Use of the molten copper having an oxygen concentration of 2 to 50 mass ppm to manufacture the copper alloy material allows the surface quality of the copper alloy material to be improved.

(4) Reducing the softening temperature of the copper alloy material facilitates processing of the copper alloy material. In addition, it is also possible to reduce energy cost of manufacturing the copper alloy material.

### EXAMPLES

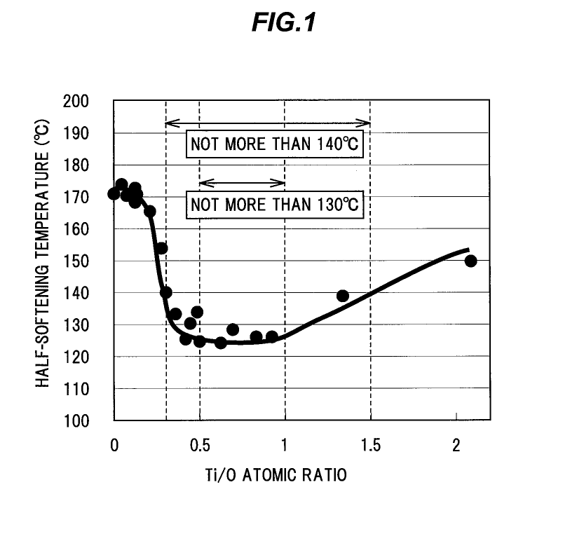

Next, Examples of the invention will be described in reference to FIG. 1 and Table 1. FIG. 1 is a characteristic diagram illustrating a relation between Ti/O atomic ratio and half-softening temperature of the copper alloy material. Meanwhile, Table 1 shows a relation among Ti/O atomic ratio, half-softening temperature, conductivity, titanium (Ti) concentration, oxygen (O) concentration and sulfur (S) concentration, and also shows the evaluation of each sample.

Here, Example 1 is a copper alloy material having a Ti/O atomic ratio of 0.5, Example 2 is a copper alloy material having a Ti/O atomic ratio of 0.93, Comparative Example 1 is a copper alloy material having a Ti/O atomic ratio of 0.042 and Comparative Example 2 is a copper alloy material having a Ti/O atomic ratio of 2.08.

8 mm-diameter copper wires were made using the respective copper alloy materials and were cold-drawn to a diameter of 2.6 mm (a compression ratio of 89.4%), and the resulting copper wires were used as samples to measure Ti/O atomic ratio, half-softening temperature, conductivity, Ti concentration, O concentration and S concentration of the copper alloy material.

The copper wires each cut into a length of 70 cm were used to measure conductivity of the copper alloy material. That is, using a four-terminal method in which a distance between current terminals was set to 60 cm and a distance between voltage terminals was set to 50 cm, 4 A of current was fed to each copper wire and the conductivity was measured at room temperature.

The half-softening temperature of the copper alloy material was measured as follow. That is, a tensile strength at room temperature and a tensile strength after annealing each copper wire at a temperature of 100 to 400° C. for 1 hour were measured. Then, a heat treatment temperature applied to or used for a copper wire having a tensile strength intermediate between the tensile strength at room temperature and the tensile strength after annealing was derived. The derived heat treatment temperature was defined as the half-softening temperature.

The Ti concentration and the Ti/O atomic ratio were measured by an ICP emission analyzer. The O and S concentrations of the copper alloy material were measured by an infrared emission analyzer (Leco: trademark).

### Example 1

In Example 1, it was confirmed that adjusting the Ti/O atomic ratio to 0.5 resulted in the half-softening temperature of 125° C. and the conductivity of 101.8% IACS. Here, the samples having a half-softening temperature of less than 140° C. and a conductivity of more than 98% IACS were evaluated as “◯ (good)” and other samples were evaluated as “X (bad)”. The copper alloy material in Example 1 had a half-softening temperature of less than 130° C. and a conductivity of more than 98% IACS, and was thus evaluated as “◯”. In Example 1, the Ti concentration was 12 mass ppm, the O concentration was 8 mass ppm and the S concentration was 4 mass ppm.

### Example 2

In Example 2, it was confirmed that adjusting the Ti/O atomic ratio to 0.93 resulted in the half-softening temperature of 126.2° C. and the conductivity of 101.5% IACS. The copper alloy material in Example 2 had a half-softening temperature of less than 130° C. and a conductivity of more than 98% IACS, and was thus evaluated as “◯”. In Example 2, the Ti concentration was 25 mass ppm, the O concentration was 9 mass ppm and the S concentration was 3 mass ppm.

### Comparative Example 1

In Comparative Example 1, it was confirmed that adjusting the Ti/O atomic ratio to 0.042 resulted in the copper alloy material having the half-softening temperature of 173.8° C. and the conductivity of 102.0% IACS. The copper alloy material in Comparative Example 1 had a conductivity of more than 98% IACS but has a half-softening temperature of more than 140° C., and was thus evaluated as “X”. In Comparative Example 1, the Ti concentration was 1 mass ppm, the O concentration was 8 mass ppm and the S concentration was 4 mass ppm.

### Comparative Example 2

In Comparative Example 2, it was confirmed that adjusting the Ti/O atomic ratio to 2.08 resulted in the copper alloy material having the half-softening temperature of 150.0° C. and the conductivity of 97.5% IACS. The copper alloy material in Comparative Example 2 had a conductivity of less than 98% IACS and a half-softening temperature of more than 140° C., and was thus evaluated as “X”. In Comparative Example 2, the Ti concentration was 50 mass ppm, the O concentration was 8 mass ppm and the S concentration was 3 mass ppm.

TABLE 1

| | Ti/O atomic | Half-softening | Conductivity | Ti concentration | O concentration | S concentration | |
|---|---|---|---|---|---|---|---|
| | ratio | temperature (° C.) | (% IACS) | (mass ppm) | (mass ppm) | (mass ppm) | Evaluation |
| Example 1 | 0.5 | 125.0 | 101.8 | 12 | 8 | 4 | ◯ |
| Example 2 | 0.93 | 126.2 | 101.5 | 25 | 9 | 3 | ◯ |
| Comparative | 0.042 | 173.8 | 102.0 | 1 | 8 | 4 | X |
| Example 1 | | | | | | | |
| Comparative | 2.08 | 150 | 97.5 | 50 | 8 | 3 | X |
| Example 2 | | | | | | | |

It was confirmed from FIG. 1 that the half-softening temperature of the copper alloy material is less than 140° C. when the TWO atomic ratio is in a range of 0.33 to 1.5. It should be noted that FIG. 1 also shows data of copper alloy materials which are not shown in Table 1.

Furthermore, it was confirmed that the half-softening temperature of the copper alloy material is less than 130° C. when the TWO atomic ratio is in a range of 0.5 to 1. In addition, it was confirmed from Table 1 that the copper alloy materials having the TWO atomic ratio in a range of 0.5 to 1 have a conductivity of not less than 98% IACS.

Modification

It should be noted that the embodiment of the invention is not limited to the embodiment described above and various changes can be made without departing from the gist of the invention. For example, the copper alloy material can be embodied not only as a copper wire softened at low temperature but also in other forms such as copper foil, copper sheet or copper rod.

Alternatively, it may be embodied as a twisted wire formed by twisting plural copper alloy materials.

In addition, it may be embodied as a power cable or signal cable formed by providing an insulation layer on the outer periphery of a copper wire using the copper alloy material or a twisted wire using the copper alloy material.

It may be embodied as a coaxial cable formed by providing an insulation layer and a braided wire on the outer periphery of a center conductor formed of the copper alloy material.

Although the copper alloy material manufactured by a SCR continuous casting and rolling machine has been described in the embodiment, the copper alloy material may be manufactured by an apparatus integrally performing casting and rolling, such as twin-roll continuous casting and rolling apparatus or Properzi continuous casting and rolling machine.

What is claimed is:

1. A copper alloy material, comprising:
an additional element M comprising Ti; and
a balance consisting copper and an inevitable impurity,
wherein an atomic ratio of the additional element M to oxygen is in a range of 0.33≦M/O≦1.5.

2. The copper alloy material according to claim 1, further comprising a half-softening temperature of less than 140° C.

3. The copper alloy material according to claim 1, wherein the atomic ratio of the additional element M to oxygen is in a range of 0.5≦M/O≦1.

4. The copper alloy material according to claim 3, further comprising a half-softening temperature of less than 130° C.

5. The copper alloy material according to claim 1, further comprising an electrical conductivity of not less than 98% IACS.

6. The copper alloy material according to claim 1, wherein a molten copper before introducing the additional element M has an oxygen concentration of 2 to not more than 50 mass ppm.

7. The copper alloy material according to claim 1, wherein the copper alloy material is formed by hot-rolling a cast product obtained by continuously casting.
